(19) United States
(12) Patent Application Publication
(10) Pub. No.: US 2016/0188655 A1
(43) Pub. Date: Jun. 30, 2016

(54) DETERMINING AN ERROR DURING DATA EXTRACTING

(71) Applicant: Longsand Limited, Cambridge (GB)

(72) Inventors: Phillip Greenwood, Cambridge (GB); Sean Blanchflower, Cambridge (GB)

(21) Appl. No.: 14/910,563

(22) PCT Filed: Aug. 29, 2013
(86) PCT No.: PCT/EP2013/067948

§ 371 Date: Feb. 5, 2016

(51) Int. Cl. G06F 17/30

(52) U.S. Cl. CPC G06F 17/30371; G06F 17/30011; G06F 17/30377

(57) ABSTRACT

Examples of determining an error during data extracting are disclosed. According to aspects of the present disclosure, one example system may include one or more processors, a memory, and an error data store. The system may also include a capture module stored in the memory and executing on at least one of the one or more processors to capture a document in an original file format from a document repository. Further, the system may include an extraction module stored in the memory and executing on at least one of the one or more processors to extract document data from the captured document. The system may include an extraction error module stored in the memory and executing on at least one of the one or more processors to determine whether an error occurred during the data extracting and to store the captured document causing the error into the error data store.

### BACKGROUND

As the number of users and devices on the Internet have increased, so too has the amount of data related to those users and devices. Moreover, users have increasingly relied on digital documents and other data, which the users may access through document search systems or document management systems. These document search systems enable users to quickly retrieve sought-after information from a variety of sources. For example, a document search system may allow a user to search for a document based on the content of the document, metadata associated with the document, or both.

### BRIEF DESCRIPTION OF THE DRAWINGS

The following detailed description references the drawings, in which:

FIG. 1 illustrates a block diagram of a computing device for determining an error during data extracting according to examples of the present disclosure;

FIG. 2 illustrates a block diagram of a computing device for determining an error during data extracting according to examples of the present disclosure;

FIG. 3 illustrates a flow diagram of a method for determining an error during data extracting according to examples of the present disclosure; and

FIG. 4 illustrates a flow diagram of a method for determining an error during data extracting according to examples of the present disclosure.

### DETAILED DESCRIPTION

Document search systems store and index documents into a document database. Many times, this may include storing and indexing hundreds of thousands or even millions of documents of varying types. The document database may be searched for certain documents or information contained in the documents such as to the content of the documents or through metadata associated with the documents. However, before the search may occur, the documents must be ingested into the document database.

Ingestion is generally a two-part process consisting of a capture process and an extraction process. The ingestion begins with the capture process during which the document search system obtains a document (or a set of documents) in an original file format from document repositories, file systems, web servers or services, and/or other appropriate sources. After the documents are captured, data such as document information may be extracted from the captured documents. However errors may occur during the extraction process.

Previously, when errors occurred during the extraction process the document search system may have simply deleted the documents without regard to the error. Or the document search system may have stored the documents with the errors into the document search system's primary database, thereby disrupting the integrity of the document search system's primary database. Alternatively, the document search system may have terminated the ingestion process, finishing none or only part of the document ingestion. These prior systems are unreliable and may result in sporadic failures that can occur due to factors such as lack of operating system resources, configuration errors, or other similar types of failures. Such an error may cause the entire ingestion process to fail.

Various embodiments will be described below by referring to several examples of determining an error during data extraction. In one example, an error may occur during a data extraction process of an ingestion process during which documents are captured and indexed. When the error is detected, the document or documents from which the data is being extracted may be stored in a dedicated database such as an error data store. The document or documents stored in the error data store may be reviewed by a user, in one example, or may be automatically reviewed by the document search system. After review, the documents may be moved to the document search system's primary document database, may be flagged to be re-ingested by the document search system, or may be removed from the error data store.

In some implementations, incremental ingestion is not compromised by failures during the extraction process because the ingestion process is allowed to continue by isolating the documents causing an error during the extracting, allowing the ingestion to continue uninterrupted. Moreover, the integrity of the document search system's primary database may be maintained during the ingestion process. These and other advantages will be apparent from the description that follows.

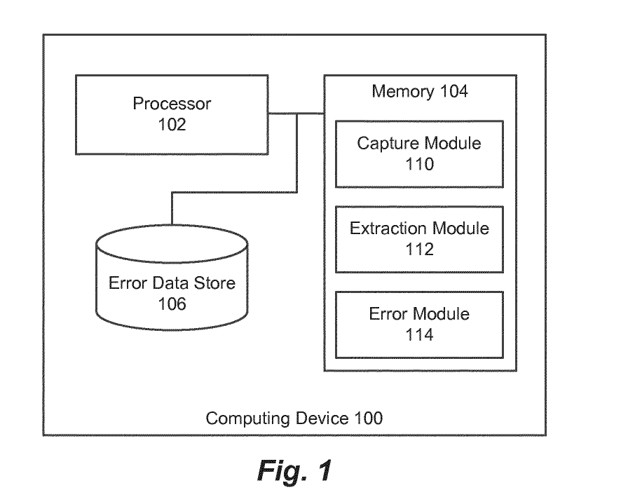

FIG. 1 illustrates a block diagram of a computing device 100 for determining an error during data extracting according to examples of the present disclosure. It should be understood that the computing device 100 may include any appropriate type of computing device, including for example smartphones, tablets, desktops, laptops, workstations, servers, smart monitors, smart televisions, digital signage, scientific instruments, retail point of sale devices, video walls, imaging devices, peripherals, or the like.

The computing device 100 may include a processor 102 that may be configured to process instructions. The instructions may be stored on a non-transitory tangible computer-readable storage medium, such as memory device 104, or on a separate device (not shown), or on any other type of volatile or non-volatile memory that stores instructions to cause a programmable processor to perform the techniques described herein. Alternatively or additionally, the computing device 100 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

The computing device 100 may also include an error data store 106. The error data store 106 may store captured documents that were determined to have caused an error during the data extracting process, such as by the error module 114. In one example, the error data store 106 may include at least two databases, which are discussed below: a review database and a graveyard database.

The computing device 100 may further include various instructions in the form of modules stored in the memory 104 and executing on the processor 102. These modules may include a capture module 110, an extraction module 112, and an error module 114. Other modules may also be utilized as will be discussed further below in other examples. In one example, these modules together may enable the computing device to ingest documents by capturing the documents and extracting data from the documents. The modules may also determine whether an error occurs during data extracting.

The capture module 110 may initiate the process for ingesting documents into a document search system such as computing device 100. For example the capture module 110 may obtain a document or documents from a document repository, file system, web server or service, or another suitable source. The document or documents may be of varying file formats. The document or documents may also include content such as text, images, formulae, etc., as well as metadata associated with the document. The metadata may include a variety of information about each document such as the documents author, title, date, revision number, version, location, file size, etc. The content of a document and its associated metadata may enable a user of a document search system, such as the computing device 100, to search for specific information about or relating to the document. The capture module 110 may capture hundreds, thousands, or even millions of documents at once and consequently may be a very time-consuming process.

After a document or set of documents has been captured by the capture module 110, data from the document including the content of the document or documents and the metadata associated therewith may be extracted by, for example, the extraction module 112. During the extraction process, the textual content and metadata associated with the documents is extracted for processing by the extraction module 112. Extracting the data from the captured document may include extracting text, images, formulae, etc., as well as metadata associated with the document. Metadata may include a variety of information about each document such as the document author, title, date, revision number, version, location, file size, etc. The extracted data, such as the content of the document and its associated metadata, may enable a user of a document search system, such as the computing device 100 or the computing device 200, to search for specific information about or related to the document.

The error module 114 determines whether an error occurs during the data extracting. Determining whether an error occurred may happen continually while the computing device 100 is extracting data from the captured document via the extraction module 112, for example, or it may happen after the computing device 100 has extracted data from the captured document. Determining whether an error occurred may include determining whether a failure occurred during the extraction process that does not result in a failure (that is, a failure that causes the entire process determining). Instead of the entire ingestion process terminating, determining whether an error occurred may include marking the captured document as having caused or experience an extraction error so that the capture document causing or experiencing an extraction error may be reviewed.

If the error module 114 determines that an error occurs during the extraction, the error module 114 may load the captured document or documents into the error data store 106. In one example, the error data store 106 may include a review database and a graveyard database, although these two databases may be combined as a single database in some implementations.

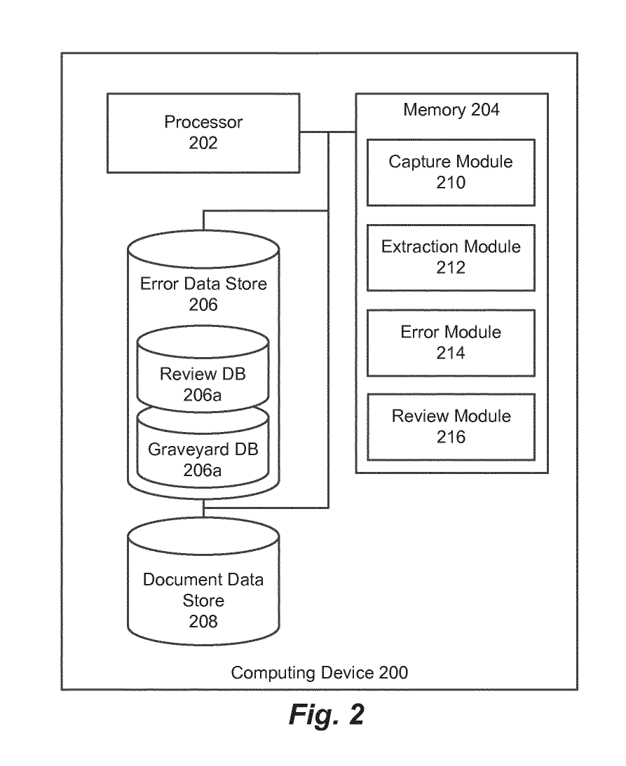

FIG. 2 illustrates a block diagram of a computing device 200 for determining an error during data extracting according to examples of the present disclosure. It should be understood that the computing device 200 may include any appropriate type of computing device, including for example smartphones, tablets, desktops, laptops, workstations, servers, smart monitors, smart televisions, digital signage, scientific instruments, retail point of sale devices, video walls, imaging devices, peripherals, or the like.

The computing device 200 may include a processor 202 that may be configured to process instructions. The instructions may be stored on a non-transitory tangible computer-readable storage medium, such as memory device 204, or on a separate device (not shown), or on any other type of volatile or non-volatile memory that stores instructions to cause a programmable processor to perform the techniques described herein. Alternatively or additionally, the computing device 200 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

The computing device 200 may also include an error data store 206 and a document data store 208. The error data store 206 may store captured documents that were determined to have caused an error during the extraction process, such as by the error module 214. In one example, the error data store 206 may include two databases, which will be discussed below: a review database 206a and a graveyard database 206b. The document data store 208 may store captured documents that were not determined to have caused an error during the extraction process and/or documents that have been reviewed as a result of being determined to have an error.

The computing device 200 may further include various instructions in the form of modules stored in the memory 204 and executing on the processor 202. These modules may include a capture module 210, an extraction module 212, an error module 214, and a review module 216. Other modules may also be utilized as will be discussed further below in other examples. In one example, these modules together may enable the computing device to ingest documents by capturing the documents and extracting data from the documents. The modules may also determine whether an error occurs during data extracting.

The capture module 210 may initiate the process for ingesting documents into a document search system such as computing device 200. For example the capture module 210 may obtain a document or documents from a document repository, file system, web server or service, or another suitable source. The document or documents may be of varying file formats. The document or documents may also include content such as text, images, formulae, etc., as well as metadata associated with the document. The metadata may include a variety of information about each document such as the documents author, title, date, revision number, version, location, file size, etc. The content of a document and its associated metadata may enable a user of a document search system, such as the computing device 200, to search for specific information about or relating to the document. The capture module 210 may capture hundreds, thousands, or even millions of documents at once and consequently may be a very time-consuming process.

After a document or set of documents has been captured by the capture module 210, data from the document including the content of the document or documents and the metadata associated there with may be extracted by, for example, the extraction module 212. During the extraction process the textual content and metadata associated with the documents is extracted for processing by the extraction module 212. Extracting the data from the captured document may include extracting text, images, formulae, etc., as well as metadata associated with the document. Metadata may include a variety of information about each document such as the document author, title, date, revision number, version, location, file size, etc. The extracted data, such as the content of the document and its associated metadata, may enable a user of a document search system, such as the computing device 100 or the computing device 200, to search for specific information about or related to the document.

The error module 214 determines whether an error occurs during the data extracting. Determining whether an error occurred may happen continually while the computing device 200 is extracting data from the captured document via the extraction module 212, for example, or it may happen after the computing device 200 has extracted data from the captured document. Determining whether an error occurred may include determining whether a failure occurred during the extraction process that does not result in a failure (that is, a failure that causes the entire process determining). Instead of the entire process terminating, determining whether an error occurred may include marking the captured document as having caused or experience an extraction error so that the capture document causing or experiencing an extraction error may be reviewed.

If the error module 214 determines that an error occurs during the extraction, the error module 214 may load the captured document or documents into the error data store 206. In one example, the error data store 206 may include a review database 206a and a graveyard database 206b, although these two databases may be combined in some implementations. The review database 206a allows for short-term storage of documents that need review following the extraction process. For example, if the error module 214 determines that an error occurred while extracting data from a captured document, the document may be stored in the review database 206a. In one example, the review database 206a stores the document along with all of its document fields. During configuration, a system administrator may indicate the length of time documents may remain in the review database 206a before being automatically moved to the graveyard database (unless some other action is first taken on the documents).

The graveyard database 206b allows for long-term storage for documents that fail the review process, in one example, or that automatically expire from the review database 206a, in another example. The graveyard database 206b may store the document along with its metadata (also referred to as “document fields,” or the graveyard database 206b may store only the document while omitting its metadata or document fields. During configuration, the system administrator may indicate which metadata or document fields, if any, should be maintained, and which metadata or document fields, if any, should be omitted. In one example, the graveyard database may store a “drereference” document field to identify the document uniquely in the data store 206 and/or select other fields relating to the document. The graveyard database 206b allows for the reduction of disk space used to store failed documents by removing some or all of the documents' associated document fields.

The computing device 200 may also include a review module 216 to enable a user to review the documents stored in the data store 206 (and in particular, in the review database 206a). The review module 216 they provide an interface to enable the user to review the error data store 206. The interface may further enable the user to cause the computing device 200 to re-extract data from the document loaded into the error data store 206. In one example, the user may review the documents stored in the review database of the data store 206 (including the review database 206a) and confirm whether each document is suitable for normal indexing (that is, can the error be ignored). If so, a document that passes the review as being suitable for normal indexing may be passed along to the document data store 208 for storing documents long term. The user may also determine that the document should be re-extracted by the extraction module 212, or that the document should be moved to the graveyard database 206b to be deleted and not re-extracted. In one example, the determinations mentioned above may be performed automatically by the computing device 200 or by other suitable devices or logic and may not be performed entirely or at all by a user. If the user or the computing device determines that the document should be re-extracted, the document may bypass the capture process in one example, or the document may be re-captured, so as to preserve any metadata. If the actual document caused the error (i.e., it was corrupt), the user may fix the document before the re-capture process.

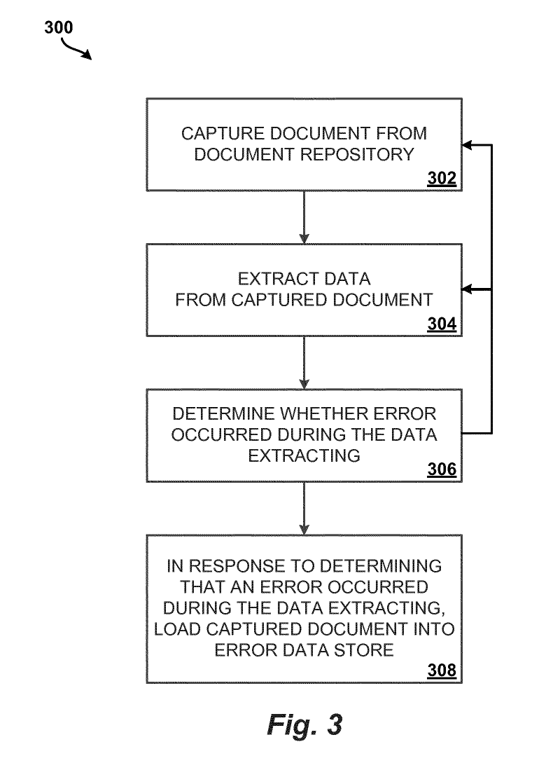

FIG. 3 illustrates a flow diagram of a method 300 for determining an error during data extracting according to examples of the present disclosure. The method 300 may be executed by a computing system or a computing device such as computing device 100 and computing device 200 of FIGS. 1 and 2 respectively. In one example, the method 300 may include: capturing, by a computing system, a document from a document repository (block 302); extracting, by the computing system, data from the captured document (block 304); determining, by the computing system, whether an error occurred during the data extracting (block 306); and in response to determining that an error occurred during the data extracting, loading, by the computing system, the captured document into an error data store. (block 308).

At block 302, the method 300 may include capturing, by a computing system, a document from a document repository. Capturing the document from the document repository may include obtaining a document (or a set of documents) from one or more document repositories including file systems, web servers or services, and other appropriate sources. The capture process may capture a single document multiple documents at once. Capturing multiple documents may include capturing hundreds, thousands, or even millions of documents at the same time. Once the document is captured, the method 300 may continue to block 304.

At block 304, the method 300 may include extracting, by the computing system, data from the captured document. The captured document is the document (or a set of documents) that was captured from the document repository. Extracting the data from the captured document may include extracting text, images, formulae, etc., as well as metadata associated with the document. Metadata may include a variety of information about each document such as the document author, title, date, revision number, version, location, file size, etc. The extracted data, such as the content of the document and its associated metadata, may enable a user of a document search system, such as the computing device 100 or the computing device 200, to search for specific information about or related to the document. The method 300 may continue to block 306.

At block 306, the method 300 may include determining, by computing system, whether an error occurred during the data extracting. Determining whether an error occurred may happen continually while the computing system is extracting data from the captured document at block 304, for example, or it may happen after the system has extracted data from the captured document. Determining whether an error occurred may include determining whether a failure occurred during the extraction process that does not result in failure (that is, a failure that causes the entire process to terminate). Instead of simply loading the captured document having the error into a document data store, determining whether an error occurred may include marking the captured document as having caused or experienced an extraction error so that the captured document causing or experiencing an extraction error may be reviewed. Moreover, the captured document causing or experiencing an extraction error may also be passed back to the capture process and/or extraction process for re-capture and/or re-extraction. The method 300 may then continue to block 308.

At block 308, the method 300 may include in response to determining that an error occurred during the data extracting, loading, by the computing system, the captured document into an error data store. Once it is determined that an error occurred during data extracting, such as at block 306, the computing system, such as computing device 100 or computing device 200, may maintain a data store such error data for loading the capture document into, in response to determining that an error occurred during the data extracting. The error data store, such as error data store 106 of FIG. 1 or error data store 206 of FIG. 2, for example, may store captured documents that were determined to have caused an error (or documents for which an error was determined to have occurred) during the data extracting process. In one example the error data store may include at least two databases as discussed herein: a review database and graveyard database.

Additional processes also may be included. For example, the method 300 may further include loading the captured document into a document data store such as document data store 208 of FIG. 2, for example, in response to determining that the extracting did not cause an error. In addition, the method 300 may include providing, by the computing system, an interface to enable a user to review the error data store. The review may include the user assigning the document to be deleted, to be moved to the document data store, or to be re-captured and/or re-extracted. The interface may further enable the user to cause the computing system to re-capture and/or re-extract data from the document loaded into the error data store by returning to blocks 302 and/or 304. The method 300 may also include re-extracting, by the computing system, document information from the captured document, such as after the error has been corrected or after the user has determined that the document should undergo re-extraction. It should be understood that the processes depicted in FIG. 3 represent illustrations, and that other processes may be added or existing processes may be removed, modified, or rearranged without departing from the scope and spirit of the present disclosure.

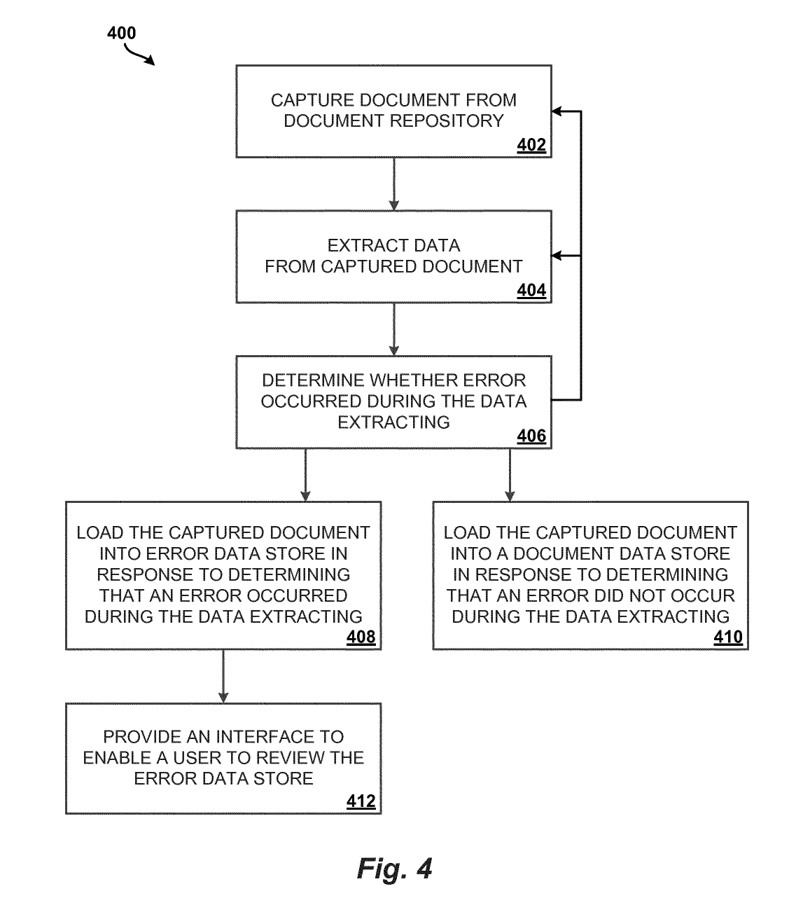

FIG. 4 illustrates a flow diagram of a method for 400 for determining an error during data extracting according to examples of the present disclosure. The method 400 may be executed by a computing system or a computing device such as computing device 100 and computing device 200 of FIGS. 1 and 2 respectively. In one example, the method 400 may include at least the following: capturing, by a computing system, a document from a document repository (block 402); extracting, by computing system, data from the captured document (block 404); determining, by a computing system, whether an error occurred during the data extracting (block 406); loading, by a computing system, the captured document into an error store in response to determining that the extracting caused an error. (408); and providing, by a computing system, an interface to enable a user to review the error data store (block 412).

At block 402, the method 400 may include capturing, by a computing system, a document from a document repository. Capture the document from the document repository may include obtaining a document (or a set of documents) from one or more document repositories including file systems, web servers or services, and other appropriate sources. The capture process may capture a single document multiple documents at once. Capturing multiple documents may include capturing hundreds, thousands, or even millions of documents at the same time. Once the document is captured, the method 400 may continue to block 404.

At block 404, the method 400 may include extracting, by the computing system, data from the captured document. The captured document is the document (with a set of documents) that was captured from the document repository. Extracting the data from the captured document may include extracting text, images, formulae, etc., as well as metadata associated with the document. Metadata may include a variety of information about each document such as the document author, title, date, revision number, version, location, file size, etc. The extracted data, such as the content of the document and its associated metadata, may enable a user of a document search system, such as the computing device 100 or the computing device 200, to search for specific information about or related to the document. The method 400 may continue to block 406.

At block 406, the method 400 may include determining, by computing system, whether an error occurred during the data extracting. Determining whether an error occurred may happen continually while the computing system is extracting data from the captured document at block 404, for example, or it may happen after the system has extracted data from the captured document. Determining whether an error occurred may include determining whether a failure occurred during the extraction process that does not result in failure (that is, a failure that causes the entire process to terminate). Instead of simply loading the captured document having the error into a document data store determining whether an error occurred may include marking the captured document as having caused or experienced an extraction error so that the captured document causing or experiencing an extraction error may be reviewed. Moreover, the captured document causing or experiencing an extraction air may also be passed back to the extraction process for re-capture and/or re-extraction at blocks 402 and/or 404. The method 400 may then continue to block 408.

At block 408, the method 400 may include loading, by a computing system, the captured document into an error store in response to determining that the extracting caused an error. Once it is determined that an error occurred during data extracting, such as at block 406, the computing system, such as computing device 100 or computing device 200, may maintain a data store such error data for loading the capture document into, in response to determining that an error occurred during the data extracting. The error data store, such as error data store 106 of FIG. 1 or error data store 206 of FIG. 2, for example, may store captured documents that were determined to have caused an error (or documents for which an error was determined to have occurred) during the data extracting process. In one example the error data store may include at least two databases as discussed herein: a review database and graveyard database. The process may then continue to block 412.

At block 412, the method 400 may include, providing by the computing system, an interface to enable a user to review the error data store. For example the computing system may display an interface on attached display, monitor, or other suitable screen. The interface may enable a user to review the captured document or documents stored in the error data store. The user may assess each of the documents and any related information such as an error code for a reason that the error occurred, and the user may assign the document to be deleted, to be moved to the document data store, or to be re-captured and/or re-extracted. In one example, instead of providing an interface to enable user to review the error data store, the computing system may automatically review the error data store and rely on existing and word user-defined rules and logic to assign the documents in the error data store to be deleted, to be moved to the document data store, or to be re-extracted.

Additional processes also may be included. For example, the method 400 may further include loading the captured document into a document data store in response to determining that an error did not occur during the data extracting as illustrated at block 410. In one example, the captured document may be loaded into document data store for storing documents and document data upon successful completion of the process for extracting data from the captured document. In addition, captured documents that are loaded into the error data store may subsequently be loaded into the document data store after review and/or after re-capture and/or re-extraction. It should be understood that the processes depicted in FIG. 4 represent illustrations, and that other processes may be added or existing processes may be removed, modified, or rearranged without departing from the scope and spirit of the present disclosure.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A system comprising:
one or more processors;
a memory;
an error data store;
a capture module stored in the memory and executing on at least one of the one or more processors to capture a document in an original file format from a document repository;
an extraction module stored in the memory and executing on at least one of the one or more processors to extract document data from the captured document; and
an extraction error module stored in the memory and executing on at least one of the one or more processors to determine whether an error occurred during the data extracting and to store the captured document causing the error into the error data store.

2. The system of claim 1, further comprising:
a document data store, where in the extraction error module stores the captured document into the document data store if no error occurred during the data extracting.

3. The system of claim 1, further comprising:
a review module stored in the memory and executing on at least one of the one or more processors to provide an interface to enable a user to review the error data store.

4. The system of claim 3, wherein the interface further enables the user to cause the computing system to re-extract data from the document loaded into the error data store.

5. The system of claim 1, wherein the document data extracted from the captured document includes textual content and metadata.

6. A method comprising:
capturing, by a computing system, a document from a document repository;
extracting, by the computing system, data from the captured document;
determining, by the computing system, whether an error occurred during the data extracting; and
in response to determining that the extracting caused an error, loading, by the computing system, the captured document into an error data store.

7. The method of claim 6, further comprising:
providing, by the computing system, an interface to enable a user to review the error data store.

8. The method of claim 7, wherein the interface further enables the user to cause the computing system to re-extract data from the document loaded into the error data store.

9. The method of claim 6, further comprising:
re-capturing, by the computing system, the document from the document repository; and
re-extracting, by the computing system, document information from the re-captured document.

10. The method of claim 6, further comprising:
in response to determining that the extracting did not cause an error, loading the captured document into a document data store.

11. The method of claim 6, wherein the data from the captured document includes textual content and metadata.

12. A non-transitory computer-readable storage medium storing instructions that, when executed by a processor, cause the processor to:
capture a document from a document repository;
extract data from the captured document;
determine whether an error occurred during the data extracting;
load the captured document into an error data store in response to determining that the extracting caused an error; and
provide an interface to enable a user to review the error data store.

13. The non-transitory computer-readable storage medium of claim 12, further storing instructions that, when executed by the processor, cause the processor to:
load captured document into a document data store in response to determining that the extracting did not cause an error.

14. The non-transitory computer-readable storage medium of claim 12, further storing instructions that, when executed by the processor, cause the processor to:
re-capture the document from the document repository; and
re-extract document information from the re-captured document after the error has been corrected.

15. The non-transitory computer-readable storage medium of claim 12, wherein the interface further enables the user to cause the computing system to re-extract data from the document loaded into the error data store.
